(19) United States
(12) Patent Application Publication
(10) Pub. No.: US 2026/0116264 A1
(43) Pub. Date: Apr. 30, 2026

(54) TRANSVERSE SUPPORT ARRANGEMENT FOR A SEAT OF A MOTOR VEHICLE, AND MOTOR VEHICLE HAVING SUCH A TRANSVERSE SUPPORT ARRANGEMENT FOR A SEAT

(71) Applicant: Volkswagen Aktiengesellschaft, Wolfsburg (DE)

(72) Inventors: Philip ZIMMERMANN, Ahlen (DE); Johannes SPERBER, Wolfsburg (DE)

(73) Assignee: Volkswagen Aktiengesellschaft, Wolfsburg (DE)

(21) Appl. No.: 19/427,090

(22) Filed: Dec. 19, 2025

Related U.S. Application Data
(63) Continuation of application No. PCT/EP2024/066999, filed on Jun. 18, 2024.

(30) Foreign Application Priority Data
Jun. 19, 2023 (DE) 10 2023 205 721.2

(51) Int. Cl. B60N 2/005; B62D 21/03; B62D 21/15; B62D 25/02

(52) U.S. Cl. CPC B60N 2/005; B62D 21/03; B62D 21/15; B62D 25/025

(57) ABSTRACT

A seat crossmember arrangement of a motor vehicle, with a seat crossmember having a one- or multi-part construction, and extending at least from a vehicle-external crossmember section, across a seat connection section, to a vehicle-internal crossmember section, with the seat connection section extending at least over the width of the connecting elements of a seat, and the vehicle-external crossmember section and the vehicle-internal crossmember section each adjoining the seat connection section in the vehicle transverse direction. When the vehicle-internal crossmember section is subjected to stress in the vehicle transverse direction, it is structurally designed for a medium deformation force level that is higher than the deformation force level in the vehicle-external crossmember section, and that is lower than the deformation force level in the seat connection section.

This nonprovisional application is a continuation of International Application No. PCT/EP2024/066999, which was filed on Jun. 18, 2024, and which claims priority to German Patent Application No. 10 2023 205 721.2, which was filed in Germany on Jun. 19, 2023, and which are both herein incorporated by reference.

### BACKGROUND OF THE INVENTION

### Field of the Invention

The invention relates to a seat crossmember arrangement of a motor vehicle, and to a motor vehicle having such a seat crossmember. Such a seat crossmember may extend through the passenger compartment or beneath the passenger compartment of a motor vehicle.

### Description of the Background Art

A motor vehicle floor structure of a motor vehicle is known from EP 3 190 033 A1, which corresponds to US 2017/0158039, and is manufactured, at least in part, from fiber-reinforced plastic to save weight. This motor vehicle floor structure is combined with metal frame elements and a metal crossmember. The metal crossmember is intended for connection of a vehicle seat to the vehicle body. Specific structural designs of the motor vehicle floor structure, of the metal frame elements, or of the metal crossmember in conjunction with a vehicle seat for external actions of force in the vehicle transverse direction are not described or shown.

A vehicle floor structure of a motor vehicle is known from US 2022/0144063 A1, relating to a design for protecting a battery housing situated below a passenger compartment. Structural designs of the vehicle floor structure in conjunction with a vehicle seat for external actions of force in the vehicle transverse direction are not described or shown.

A protective structure in a motor vehicle is known from US 2017/0217297 A1, which extends from a side skirt externally mounted on the motor vehicle, across two load paths, to a central tunnel of the motor vehicle. One of the load paths leads across the seat crossmember, and the other load path leads across the floor panel. A battery housing of a vehicle battery is situated in a protected manner in the vehicle vertical direction, viewed between the floor panel and the seat crossmember. Structural designs of the vehicle floor structure itself in conjunction with a vehicle seat for external actions of force in the vehicle transverse direction are not described or shown.

### SUMMARY OF THE INVENTION

It is therefore an object of the present invention is to provide a seat crossmember arrangement of a motor vehicle, and a motor vehicle having such a seat crossmember arrangement, which on the one hand has low weight and on the other hand provide a high level of protection for a person sitting on a vehicle seat that is fixedly connected to the seat crossmember.

A seat crossmember arrangement of a motor vehicle according to an example of the invention has a seat crossmember having a one- or multi-part construction, and extending at least from a vehicle-external crossmember section, across a seat connection section, to a vehicle-internal crossmember section, with the seat connection section extending at least over the width of the connecting elements of a seat. In addition, the vehicle-external crossmember section and the vehicle-internal crossmember section each adjoin the seat connection section in the vehicle transverse direction. When the vehicle-internal crossmember section is subjected to stress in the vehicle transverse direction, it is structurally designed for a medium deformation force level that is higher than the deformation force level in the vehicle-external crossmember section, and that is lower than the deformation force level in the seat connection section. In other words, the invention provides a seat crossmember arrangement having a two-stage force level. On the one hand, this allows the seat crossmember to be implemented using lightweight construction measures with only a low weight of the components. On the other hand, due to the design, the safety for a person being transported in such a motor vehicle may be increased, since the additional vehicle-internal crossmember section allows a displacement of the seat connection section toward the center of the vehicle after the vehicle-external region has already absorbed energy, in that the vehicle-internal crossmember section is additionally then at least partially compressed. A vehicle seat that is fixedly connected to the seat crossmember can thus be displaced farther toward the center of the vehicle, viewed in the vehicle transverse direction, as a result of which a person sitting on a vehicle seat is provided with additional survival space.

In the seat crossmember arrangement according to an example of the invention, the vehicle-external crossmember section is formed by a side skirt, and/or the vehicle-external crossmember section is situated on the vehicle-internal side of a side skirt, viewed in the vehicle transverse direction. Accordingly, depending on the space conditions in the vehicle transverse direction of the motor vehicle in question, the crossmember section having the low deformation force level may be provided, at least partially or completely, at a side skirt itself. Or, if space conditions permit, as an alternative or in addition to a side skirt having a low deformation force level, the vehicle-external crossmember section is designed as part of the crossmember which adjoins the side skirt on the inner side.

Regardless of which of the above-described variants is implemented, the crossmember is preferably fixedly connected to the side skirt and extends across the entire vehicle width between the respective side skirts, in the vehicle transverse direction (y direction). This results in a particularly rigid arrangement between the side skirts and the seat crossmember.

In an example of the seat crossmember arrangement, design measures are provided for adapting the deformation force level in the vehicle-internal crossmember section and/or in the vehicle-external crossmember section. This is intended to mean in particular structural modifications of a crossmember which can extend in one piece with a constant cross-sectional profile, from the right side skirt to the left side skirt. This may be achieved, for example, by forming suitable weak points in those areas having a medium deformation force level and a low deformation force level. A low deformation force level may thus be achieved, for example, by forming hole patterns with fairly large through openings, by fairly large recesses, and/or by fairly well-pronounced and/or fairly large embossments, and a moderate deformation force level may be achieved by forming medium-sized through openings, by medium-sized recesses, and/or moderately pronounced and/or medium-sized embossments. Hole patterns with circular through openings are particularly preferred, with the size of the diameters and/or the spacings between the through openings preferably being varied in order to vary the force level. The through openings are preferably equidistantly spaced within a crossmember section.

The seat connection section, the vehicle-internal crossmember section, and/or the vehicle-external crossmember section may be formed from separate elements, each having a different cross-sectional geometry and/or different cross-sectional sizes and/or different material thicknesses and/or being made of different materials. Accordingly, at least one separate element may be provided in each case for adapting the deformation force level in the vehicle-internal crossmember section and/or in the vehicle-external crossmember section.

Separate elements can be understood to mean not only elements that are able to absorb energy by plastic deformation, but also elements that are movable relative to one another, for example hydraulic or pneumatic cylinders or other devices which are pushed together and may likewise be deformed when certain deformation forces acting in the vehicle transverse direction are exceeded. One advantage of such cylinders or other devices is that they may be moved back into the original position by exerting a counterforce, so that a collision-related deformation is reversible and may be cancelled. Thus, it is also not absolutely necessary to replace the element after an accident event. It may be sufficient to return the relatively movable element to its original state.

At least one tailored blank can be provided or arranged for adapting the deformation force level in the vehicle-internal crossmember section and/or in the vehicle-external crossmember section. In this regard, reference is made in particular to tailored welded blanks, tailored rolled blanks, tailored strips, tailored tubes, and tailored orbitals, which are suitable individually or in combination in particular for the configuration and structural design of crossmember sections.

For a seat crossmember arrangement according to the invention, when the seat crossmember has the same profile height in the vehicle-external crossmember section, in the seat connection section, and/or in the vehicle-internal crossmember section in each case, in particular when this is true in all the stated sections, a structurally preferred variant results since it is then possible to achieve a compact design with a flat surface of the vehicle floor. The same advantages also result when individual crossmember sections have a reduced cross-sectional area that does not protrude upwardly relative to the top side of the neighboring sections.

At least one profile cross section can have a design that varies in at least one dimension for adapting the deformation force level in the vehicle-internal crossmember section and/or in the vehicle-external crossmember section. In particular, stepless transitions may be established between individual elements of a multi-part seat crossmember, for example a transition in the vehicle vertical direction from a side skirt, across an external crossmember section, to a seat connection section, or a transition from a seat connection section, across a vehicle-internal crossmember section, to a further adjoining crossmember middle section on the internal side of the vehicle.

The invention relates in particular to seat crossmember arrangements in which a battery housing of a traction battery is situated below the seat crossmember. It is preferred when the battery housing is designed in such a way that when the vehicle-external crossmember section is deformed, the battery cells in the battery housing are not damaged, or at least there is no risk of the battery cells being set on fire due to the effect of external forces.

The vehicle-external crossmember section can be designed relative to the vehicle-internal crossmember section in such a way that when an external force acts on the seat crossmember in the vehicle transverse direction, compression of the vehicle-external crossmember section is brought about in a first deformation stage, and compression of the vehicle-internal crossmember section is not brought about in a second deformation stage until even further energy must be dissipated.

The invention further relates to a motor vehicle having a seat crossmember arrangement as described above. In this regard, reference is made in particular to motor vehicles having two, three, or four seat crossmember arrangements per vehicle seat or vehicle seat row extending in parallel to one another, as described above. Reference is also made to motor vehicles having one or more vehicle seats or vehicle seat rows, with a vehicle seat or the multiple vehicle seats or vehicle seat rows being fixedly connected to the particular seat connection section.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a motor vehicle in a side view, with areas marked by dashed lines in which a seat crossmember arrangement according to the invention may be situated inside the motor vehicle,

FIG. 2 shows an example of a seat crossmember arrangement according to the invention in a schematic sectional illustration in the y-z plane of the motor vehicle,

FIG. 3 shows a schematic illustration of the deformation force level F_{def} across the deformation path s of the crossmember arrangement in the vehicle-external seat crossmember section, in the seat connection section, and in the vehicle-internal seat crossmember section,

FIG. 4 shows an example of a seat crossmember arrangement according to the invention in a schematic sectional illustration in the y-z plane of the motor vehicle,

FIG. 5 shows an example of a seat crossmember arrangement according to the invention in a schematic sectional illustration in the y-z plane of the motor vehicle, and

FIG. 6 shows an example of a seat crossmember arrangement according to the invention in a schematic sectional illustration in the y-z plane of the motor vehicle.

### DETAILED DESCRIPTION

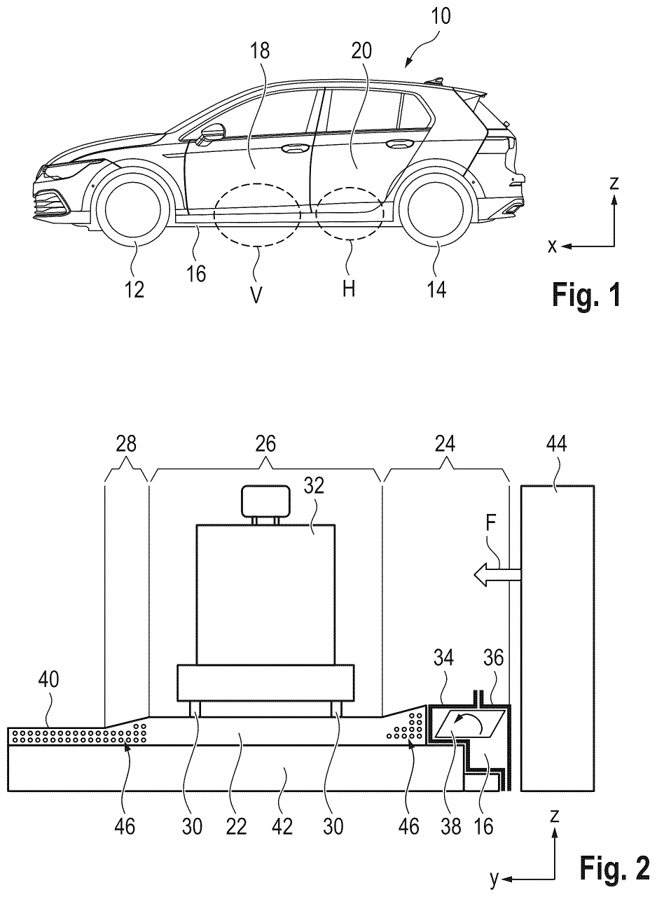

In the coordinate systems depicted in FIGS. 1 through 6, x denotes the vehicle longitudinal direction (x direction) toward the front, y denotes the vehicle transverse direction (y direction), and z denotes the vehicle vertical direction (z direction) toward the top.

FIG. 1 shows a motor vehicle 10 in a side view. Apparent in particular are the left front wheel 12, the left rear wheel 14, the left side skirt 16 extending from the front wheel 12 to the rear wheel 14, a left front door 18, and a left rear door 20. Situated in the area V of the front door 18 denoted by dashed lines, and in the area H of the rear door 20 denoted by dashed lines, are two respective seat crossmember arrangements according to the invention, which are explained below in conjunction with FIG. 2.

The seat crossmember arrangement according to the invention shown in FIG. 2 has a multi-part seat crossmember 22 extending from a vehicle-external crossmember section 24, across a seat connection section 26, to a vehicle-internal crossmember section 28. In the example shown, the seat connection section 26 extends over a width that is greater than the distance from connecting elements 30 of a seat 32, extending in the vehicle transverse direction (y direction). In the example shown, the width of the seat connection section 26 is also selected to be greater than the maximum width of the seat 32.

The vehicle-external crossmember section 24 and the vehicle-internal crossmember section 28 in each case may directly adjoin the seat connection section 26 in the vehicle transverse direction. In the example shown, the vehicle-internal crossmember section 28 further to the inside is adjoined by a crossmember middle section 40. A battery housing 42 is situated on the bottom side of the seat crossmember 22 and the side skirt 16. This is an optional element; i.e., the seat crossmember arrangement may also be implemented in a motor vehicle independently of the battery housing 42.

The vehicle-external crossmember section 24 can be regarded as extending up to the side skirt 16. In the example shown, the side skirt 16 is formed by two half-shells 34, 36 that are connected to one another via flanges. The connection is designed in particular as a weld connection. A crash element 38 is situated within the side skirt 16.

For the case that a post 44 or some other obstacle externally influences the seat crossmember arrangement in the direction of the arrow F, the vehicle-internal crossmember section 28 is structurally designed for a medium deformation force level which is higher than the deformation force level in the vehicle-external crossmember section 24, and which is lower than the deformation force level in the seat connection section 26. This design serves to absorb the kinetic energy introduced by the influence of the post 44 on the crossmember arrangement, initially solely by deformation of the vehicle-external crossmember section 24. This preferably takes place in a first deformation stage by plastic deformation of the vehicle-external crossmember section 24, preferably by buckling or some other type of deformation, until a block dimension is achieved. If the block dimension is achieved and kinetic energy is still present which must be reduced, in a second deformation stage the vehicle-internal crossmember section 28 is completely or partially compressed in order to reduce further kinetic energy. The seat 32 is thereby further displaced toward the center of the vehicle due to the compression, thus providing further protection to a person sitting on the seat 32 from an intrusion by the post 44. The survival space for the person is displaced toward the center of the vehicle by the seat crossmember arrangement according to the invention with the start of the second deformation stage, thus further increasing the safety and likelihood of survival for a person sitting on the seat 32.

In the example shown in FIG. 2, the deformation force level in the overall vehicle-external crossmember section 24, which in this example also includes the side skirt 16, is designed to be at the comparatively lowest force level L1, for example in a range between 100 kN and 1000 kN.

In the vehicle-internal crossmember section 28, the deformation force level is designed to be at a medium force level L2 which is higher than the force level L1, for example in a range between 1000 kN and 2000 kN.

In the seat connection section 26, the deformation force level is designed to be at a high force level L3 which is even higher than the force level L2. Also in the crossmember middle section 40, the deformation force level is preferably higher than the force level L2, for example likewise L3.

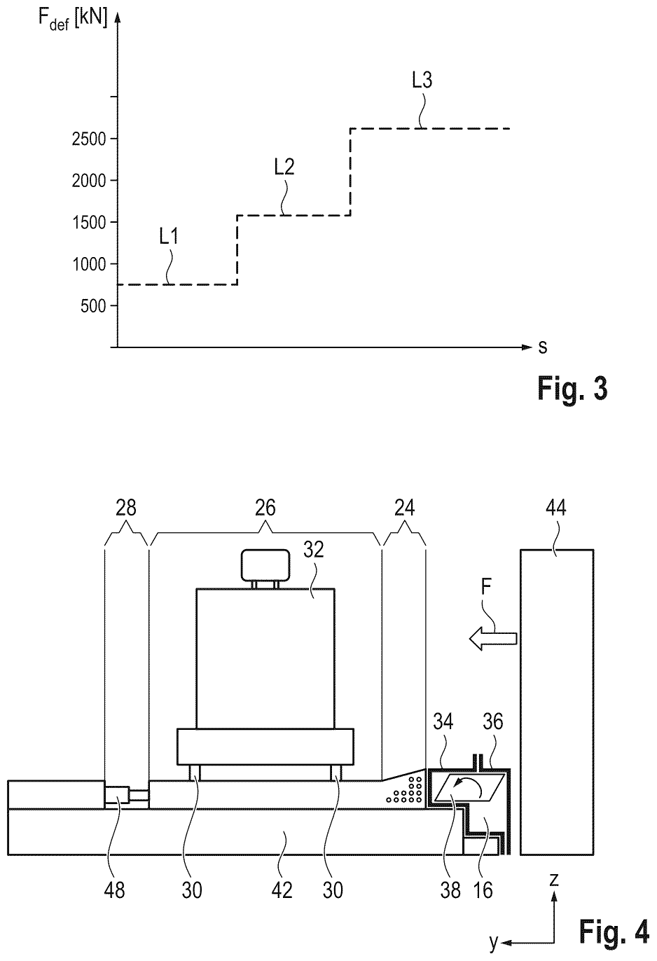

These force levels L1, L2, and L3 are depicted in the diagram illustrated in FIG. 3.

In the example shown in FIG. 2, the force levels L1, L2, and L3 are provided by suitable hole patterns 46 in the respective crossmember sections 28, 24, and are only schematically illustrated in FIG. 2.

FIGS. 4 through 6 illustrate further examples of seat crossmember arrangements according to the invention; for identical or at least functionally equivalent elements, the same reference numerals as in FIGS. 1 and 2 are used.

In the example shown in FIG. 4, a cylinder 48 is situated in the vehicle-internal seat crossmember section 28 and is set to the force level L2, which is higher than the force level L1 necessary for plastic deformation in the vehicle-external seat crossmember section 24. The cylinder 48 may in particular be a hydraulic or pneumatic damper.

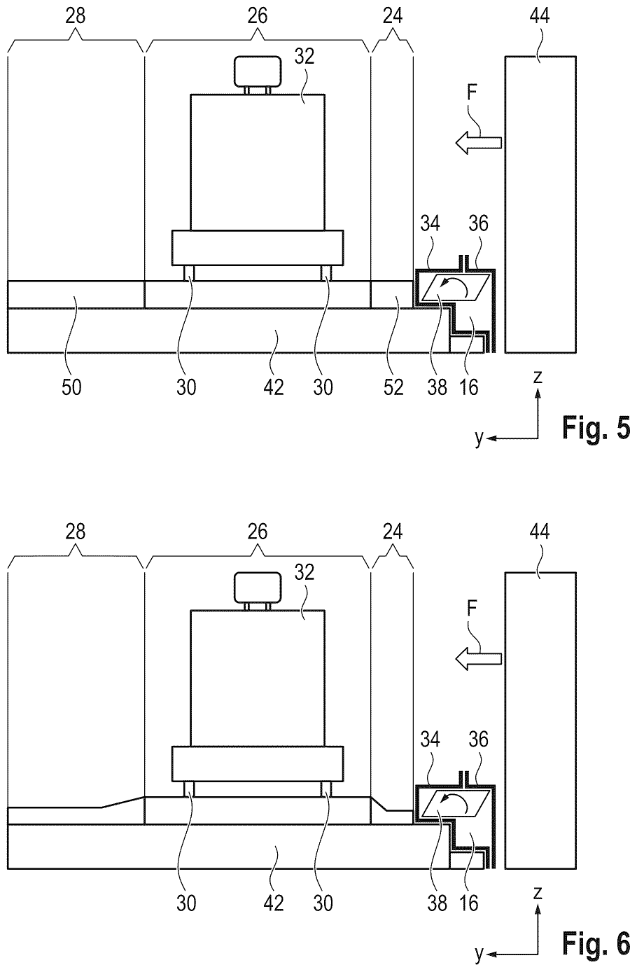

In the example shown in FIG. 5, a tailored blank 50 (only schematically illustrated) is situated in the vehicle-internal seat crossmember section 28 and is set to the force level L2, which is higher than the force level L1 necessary for plastic deformation in the vehicle-external seat crossmember section 24. A tailored blank 52 is likewise situated in the vehicle-external seat crossmember section 24.

In the example shown in FIG. 6, a profile (only schematically illustrated) having a cross-sectional area A2 that is greater than the cross-sectional area A1 in the vehicle-external seat crossmember section 24 is situated in the vehicle-internal seat crossmember section 28. The cross-sectional area A3 in the seat connection section 26 is in turn greater than the cross-sectional area A2. The cross-sectional areas A1, A2, and A2 are selected in such a way that the plastic deformation in the vehicle-external crossmember section 24 results in the force level L1, in the vehicle-internal crossmember section 28 results in the force level L2, and in the seat connection section 26 in turn results in the force level L3 in order to bring about plastic deformation in each case.

In particular, in this regard it is noted that the structural design options stated in the examples and described by separate elements may be arbitrarily combined with one another, and if necessary may also be transferred in each case to other seat crossmember sections.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A seat crossmember arrangement of a motor vehicle, the seat crossmember arrangement comprising:
a seat crossmember having a one- or multi-part construction, and extending at least from a vehicle-external crossmember section, across a seat connection section, to a vehicle-internal crossmember section, the seat connection section extending at least over a width of connecting elements of a seat, and the vehicle-external crossmember section and the vehicle-internal crossmember section each adjoining the seat connection section in a vehicle transverse direction,
wherein, when the vehicle-internal crossmember section is subjected to stress in the vehicle transverse direction, it is structurally designed for a medium deformation force level that is higher than a deformation force level in the vehicle-external crossmember section and that is lower than a deformation force level in the seat connection section.

2. The seat crossmember arrangement according to claim 1, wherein the vehicle-external crossmember section is formed by a side skirt and/or is arranged on the vehicle-internal side of a side skirt, viewed in the vehicle transverse direction.

3. The seat crossmember arrangement according to claim 1, wherein the deformation force level is adapted in the vehicle-internal crossmember section and/or in the vehicle-external crossmember section.

4. The seat crossmember arrangement according to claim 1, wherein at least one separate element is provided for adapting the deformation force level in the vehicle-internal crossmember section and/or in the vehicle-external crossmember section.

5. The seat crossmember arrangement according to claim 1, wherein at least one tailored blank is provided or arranged for adapting the deformation force level in the vehicle-internal crossmember section and/or in the vehicle-external crossmember section.

6. The seat crossmember arrangement according to claim 5, wherein the seat crossmember has a same profile height in the vehicle-external crossmember section, in the seat connection section, and/or in the vehicle-internal crossmember section.

7. The seat crossmember arrangement according to claim 1, wherein at least one profile cross section has a variable design in at least one dimension for adapting the deformation force level in the vehicle-internal crossmember section and/or in the vehicle-external crossmember section.

8. The seat crossmember arrangement according to claim 1, wherein a battery housing of a traction battery is arranged below the seat crossmember.

9. The seat crossmember arrangement according to claim 1, wherein the vehicle-external crossmember section is designed relative to the vehicle-internal crossmember section such that when an external force acts on the seat crossmember in the vehicle transverse direction, compression of the vehicle-external crossmember section is brought about in a first deformation stage, and compression of the vehicle-internal crossmember section is not brought about in a second deformation stage until even further energy must be dissipated.

10. A motor vehicle comprising the seat crossmember arrangement according to claim 1.
